(19) United States
(12) Patent Application Publication
(10) Pub. No.: US 2003/0231728 A1
(43) Pub. Date: Dec. 18, 2003

(54) Frequency estimation in a burst radio receiver

(75) Inventors: Piao Chun Phang, Singapore (SG); Boon Kiat Poh, Singapore (SG)

Correspondence Address: VENABLE, BAETJER, HOWARD AND CIVILETTI, LLP, P.O. BOX 34385, WASHINGTON, DC, 20043-9998, US

(73) Assignee: Oki Techno Centre (Singapore) Pte Ltd., Singapore (SG)

(21) Appl. No.: 10/395,173

(22) Filed: Mar. 25, 2003

(30) Foreign Application Priority Data
Jun. 17, 2002 (SG) 200203670-5

(51) Int. Cl. H04L 7/00; H04L 25/00

(52) U.S. Cl. 375/371

(57) ABSTRACT

The present invention relates to frequency offset estimation for receivers, especially for wireless burst type signals. In particular the present invention provides a method of correcting the frequency offset of a received signal by shifting the phase of said received signal by a determined phase rotation angle between repeated training sequences or training symbols. The phase rotation angle is determined by differentially multiplying a sample of a first sequence with a corresponding sample of a second sequence, and determining a phase rotation angle dependent on the difference, and which is indicative of the frequency offset estimate.

### FIELD OF THE INVENTION

The present invention relates to frequency offset estimation for receivers, especially for wireless burst type signals.

### PRIOR ART

Radio-communication systems involve the transmission of information over the air interface by modulating the radio frequency (RF) carrier by the information sources. When the signal is received, the receiver will attempt to extract the original information by adopting an appropriate demodulation technique. Demodulating digitally modulated signals entails the use of an estimated replica of the transmitting carrier for recovering the signal. However in practice, the frequency of this reference carrier will almost always differ from the received signal. This could be due to Doppler shifting or the inaccuracy of the oscillator which is only accurate to within certain number of parts per million. If the frequency uncertainty is excessive and is not adequately compensated, the performance of the demodulator will invariably be degraded to an extent that the original information cannot be reliably recovered.

To reduce the impact of frequency offset on receiver performance, some form of carrier offset compensation technique is typically employed. A well-known method known as carrier-tracking loop is commonly used to recover a reference carrier for demodulation. Based on the phase locked loop (PLL) principle, the carrier-tracking loop involves the use of a phase detector to continuously track the carrier phase for frequency and phase compensation. A parameter, particularly critical in burst mode design, known as the acquisition period is often associated with carrier tracking loop to specify the average duration taken to achieve steady state from the initial starting condition and is used as a criteria to gauge its effectiveness in acquiring burst signals.

Another known technique is the data-aided frequency estimation scheme. For example, this technique is addressed in a paper by Umberto Mengali entitled “Data-Aided Frequency Estimation for Burst Digital Transmission” (IEEE TRANSACTION ON COMMUNICATIONS, Vol 45, No 1, Jan 1997). In such methods, the estimated frequency offset can be used to tune the receiver's voltage controlled oscillator (VCO) close to the received carrier frequency for downconversion. Alternatively, the estimate could also be used to initialize the PLL to reduce the frequency acquisition time. This approach has the implementation advantage of a feedforward structure and is therefore attractive for burst synchronization,

Although conventional carrier tracking loop is widely used for removing frequency offset, it however requires the presence of a timing recovery technique. One known technique utilizes a timing detector in a feedback timing recovery loop to recover timing information. Combined with carrier tracking loop, this approach may incur an unacceptably long acquisition period which may pose significant problems when employed in burst packet transmission systems such as Time Division Duplexing (TDD) and Time Division Multiple Access (TDMA) systems. Another timing recovery method involves the correlation of oversampled signals with a locally stored preamble and detecting the peak magnitude. The sample that corresponds to the peak magnitude at the correlator output provides a coarse timing estimate. However, a large frequency offset may induce correlation loss at the magnitude peak and therefore reduce the accuracy of the timing estimate. Therefore, the combined carrier-tracking and timing correlator approach may yield unacceptable overall receiver performance if the frequency offset of the received signal is initially large.

Like carrier recovery loop, data-aided frequency estimation also requires prior timing information, which, again, may not be available in the presence of large frequency offset. These methods are normally mathematically derived under Maximum-Likelihood principle and are regarded to be the most optimum. Unfortunately, they can be extremely complicated to be efficiently realized and they often fail to perform optimally under frequency selective channels.

For the methods mentioned above to be effective, timing information must be either fully or partially available. However under the condition of a large frequency offset, reliable timing recovery may not be readily achieved. Evidently a coarse frequency compensation method that does not require prior timing information will be an attractive solution to mitigating large frequency offset. One such known method as disclosed in “SYNCHRONIZATION TECHNIQUES AND SYSTEMS FOR RADIOCOMMUNICATION, U.S. Pat. No. 6,134,286” attempts to reduce the frequency offset by a coarse frequency correction prior to fine timing and frequency corrector. This method exploits differential detection and an averaging process over the entire packet frame for frequency estimation and compensation. However this method is not robust in frequency selective channel applications as the frequency estimate is affected by channel distortion.

### SUMMARY OF THE INVENTION

The present invention aims to provide a frequency offset estimation method and apparatus which overcomes or alleviates some of the above problems. In particular, the present invention relates to a method of estimating a frequency offset of a received modulated carrier signal for coarse frequency error removal in a digital radio receiver.

In general terms the present invention provides that phase differences between corresponding samples in repeated preamble training sequences or symbols are used to generate a frequency offset estimate.

More particularly, in one aspect the present invention provides a frequency offset estimator according to claim 1.

The repeated symbols within a sequence can be treated as statistically independent when using certain well-known sequences (e.g. PN or CAZAC) which allows for an improved frequency offset estimate. As is well-known, Pseudo Random (PN) and Constant Amplitude Zero Auto-Correlation (CAZAC) sequences provide that samples within a sequence are statistically independent. This is because each sequence in the preamble is normally chosen or designed to possess noise-like or pseudo-random properties. With repeated sequences, this statistically independent property (within each sequence of the entire preamble) allows the effect of a multipath (frequency-selective) communication channel on the quality of a frequency estimate to be substantially reduced by the combined process of differential multiplication and averaging. The averaging process removes the products which have statistically independent symbols while retaining only those which has identical symbols corresponding to the repeated sequences.

Therefore the frequency offset estimator of the invention is advantageously used with sequences having statistically independent symbols, such as PN and CAZAC sequences.

As the estimator exploits the use of preambles with periodic sequences or symbols, the estimation performance of this technique is particularly robust against frequency selective channel. Due to the feedforward nature of the frequency corrector, the implementation is highly suited for burst mode modem design. In a burst mode transmission system, the frequency offset is assumed to be invariant throughout each received packet. The frequency offset of many individually received packets can however be different. Therefore a single frequency estimate determined from the preamble of each packet can be used to cancel the frequency offset of that packet. Compared to feedback architecture, a feedforward estimator allows frequency offset to be estimated very reliably in a single-shot fashion. The estimator is then shut off during the remaining packet since it is not required to track any residual frequency offset since it is assumed to be invariant.

In another aspect the present invention provides a frequency offset corrector according to claim 5.

In a further aspect the present invention provides a method of determining the frequency offset in an incoming signal according to claim 7.

In this specification, the terms repeated or periodic sequence or symbols are used interchangeably.

### BRIEF DESCRIPTION OF THE DRAWINGS

The invention will now be described in detail with reference to the following figures, by way of example only and without intending to be limiting, in which:

FIG. 1 is a functional diagram of a receiver which has a frequency offset corrector;

FIG. 2 shows the architecture of a frequency estimator according to an embodiment of the invention;

FIG. 3 shows a first embodiment frequency offset corrector;

FIG. 4 illustrates a wireless burst synchronisation preamble or training burst;

FIG. 5 shows a second embodiment frequency offset corrector;

FIG. 6 shows a digitally implemented loop filter;

FIG. 7 shows a performance comparison between the first embodiment corrector and two prior art correctors; and

FIG. 8 shows the architecture of a frequency estimator according to another embodiment of the invention.

### DETAILED DESCRIPTION

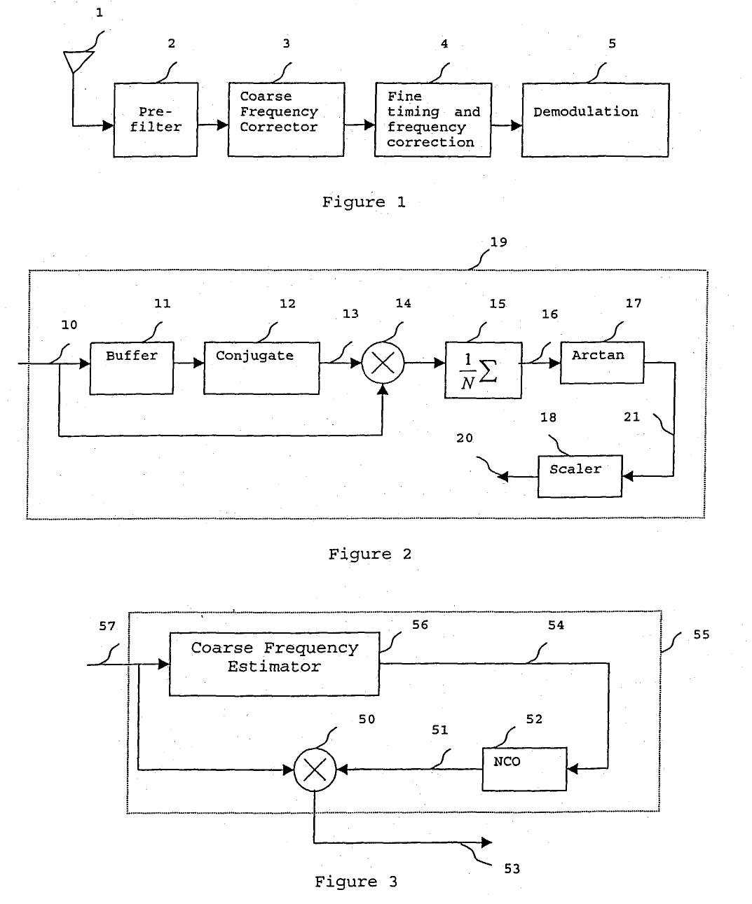

FIG. 1 is a simplified functional diagram that illustrates one possible use of a frequency estimator in a communication receiver. The carrier signal is first received by an antenna 1 and is sufficiently filtered of undesirable interference and noise by a pre-filter 2. To prevent signal distortion due to frequency offset, the bandwidth of the pre-filter should be set wider than the bandwidth of the modulating signal. The pre-filtered signal is then passed to a coarse frequency corrector 3 which comprises a frequency estimator and a derotator (or phase shifter) for reduction of frequency offset in the received signal. These component parts of the corrector 3 are described in detail below. The resultant signal may optionally be sent to a fine timing and frequency correction unit 4 and then subsequently to the demodulator 5 for final data recovery.

FIG. 2 shows the architecture of a frequency estimator 19 according to a first embodiment. Line 10 represents a signal that has been sampled by an Analog to Digital Converter with an oversampling ratio m (e.g. 2 or 4 samples/symbol). The signal is also assumed to be suitably downconverted from a RF/IF frequency to its complex baseband equivalent by a quadrature mixer (not shown). Although the final center frequency of signal 10 is lowered, the original frequency offset is still present. Depending on the length L of each sequence in the preamble (which is explained later), a memory buffer 11 of depth Lm samples is used to store and delay the incoming samples. The memory buffer may be implemented by a First-In-First-Out (FIFO) memory or a random access memory (RAM) where the buffered samples can be sequentially accessed by read logic. Complex conjugate 12 operation is then performed on the delayed samples. The delayed complex conjugate signal 13 is then multiplied with the received signal 10 by a complex multiplier 14.

Beside using FIFO and RAM to buffer (delay) the incoming samples before the differentially multiplication., another way is to use many latches or registers (e.g. D flip-flop) implemented in FPGA/ASIC for buffering. All these elements serve to delay the incoming samples. As for multiplication, either dedicated hardware complex multiplier IC or one implemented in FPGA/ASIC designed using hardware description language (e.g. Verilog) can be used to implement complex multiplication.

A fixed number of samples at the output of the multiplier 14 are then averaged by an averager 15 to reduce the noise variance. The minimum number of samples at the output of the multiplier should preferably correspond to the number of symbols in each sequence. The maximum length is limited to only the number of symbols in the entire preamble. In practice, the number of samples used for averaging depends on the required accuracy of the estimate which can be readily determined using computer simulation.

Unit 17 implements an “inverse tangent” function on the complex samples 16 output by the averager 15 in order to compute an estimated phase rotated angle 21 which is proportional to the frequency offset.

Unit 17 may be implemented as a Look-Up-Table (LUT) in a form of Read-Only-Memory (ROM) which is pre-stored with computed coefficients. Alternatively, digital logic design can be used to implement the “inverse tangent” function that may consume several clock cycles before the final result is determined. The estimated rotated angle 21 is then scaled by a scaler 18.

The scaler essentially multiplies the averaged terms at the output of inverse tangent with a 1/(2×π×16) or without loss of generality 1/(2×π×L) to eliminate the frequency bias. As will be seen from equation 3 below, the frequency estimate will yield inaccurate or biased result if the scaler, is not used.

FIG. 3 shows an embodiment of a frequency estimator here referenced 56 (for example the estimator 19 of FIG. 2) implemented as part of a coarse frequency corrector unit 55. The frequency estimate 54 as generated by the frequency estimator 56 initialises a Numerical Control Oscillator (NCO) 52 to generate a sinusoid carrier 51 with a frequency reversed with respect to the incoming signal 57. The NCO is a device which can be programmed to generate a complex sinusoid at a specific frequency. The angle of the sinusoid (e.g. angle “2πf_{c}t” of a generated complex carrier signal “exp(j2f_{c}t)”) can be programmed to increment or decrement. Increment means f_{c} is a positive number while decrement implies a negative f_{c}. To generate a sinusoid carrier 51 with a reversed frequency implies that the sign of f_{c} to be programmed into the NCO is opposite to the sign of frequency estimate.

The construction of a NCO typically comprises a phase register that supplies an input to an accumulator for generating a carrier signal via a Look-Up-Table. The value stored in the phase register corresponds to, the desired frequency of the NCO output. The generated reference carrier signal 51 is mixed with the incoming signal 57 by a complex multiplier 50 (mixer) to produce a coarse frequency offset corrected signal 53. The mixer is a complex multiplier which can be digitally implemented in hardware or software. The term ‘mix’ is borrowed from the RF terminology.

The resultant signal 53 with a certain remaining residual frequency error, if desired, can be transfer to other fine-frequency correction units such as carrier tracing loop or alternatively, go through another identical coarse frequency corrector 55 to yield a signal having an even finer frequency offset. Depending on the accuracy required on the final residual frequency error, the incoming signal 57 could pass through several stages of frequency correction unit 55.

In an example, a digitised IF (Intermediate Frequency) carrier signal may be designed to be at 4 Mhz with a maximum frequency offset of +/−150 Khz, a locally generated reference signal of 4 Mhz +frequency estimate will yield a resultant baseband signal with a residual frequency offset (e.g. at maximum of tens of Khz) depending on the estimation accuracy due to Signal to Noise Ratio (SNR).

As mentioned previously, this coarse frequency estimator (19,56) works in parallel with the transmission of the preamble. Sequences used in the preamble have to be periodic with at least two repetitions for proper functioning. One such example is a Pseudo Random (PN) sequence and another is known as Constant Amplitude Zero Auto-Correlation (CAZAC) sequence. The common property that these two sequences enjoy is that the symbols resemble the characteristic of white noise and can therefore be statistically treated as independent. This property is exploited by the embodiment.

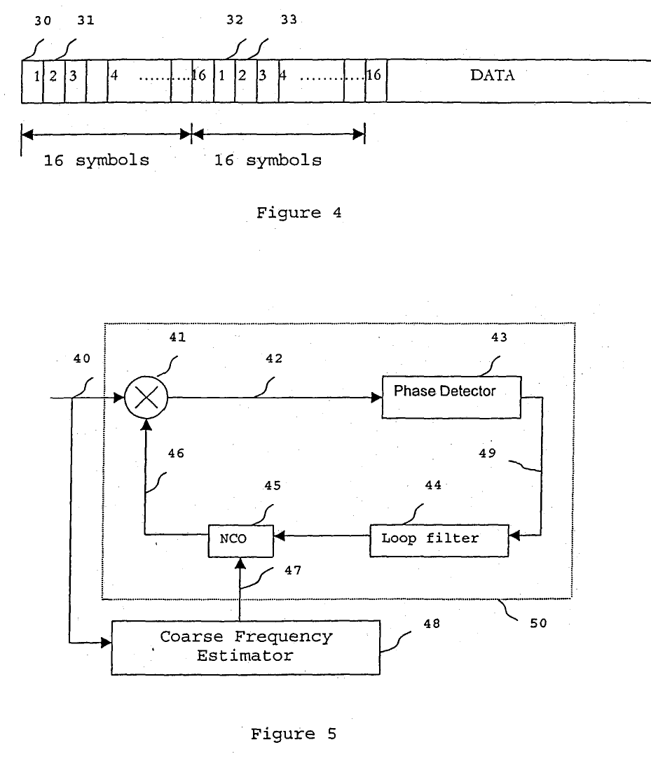

An illustration of a preamble with the periodic sequences is shown in FIG. 4. In the figure, the length of the sequence L is 16 symbols and is repeated twice. The number of sequences used depends on the requirement of the estimation accuracy and on the limit of the transmission overhead imposed on the desired throughput.

Assuming a received QPSK modulated sample with a oversampling ratio m is represented as

$${r}_{n} = {ⅇ}^{j 2 π fn} \sum {h}_{k} {a}_{n - k} + {n}_{n} \qquad ( 1 )$$

where hₖ, aₙ, f and nₙ are the Channel Impulse Response (CIR), transmitted preamble symbols, normalized (to symbol rate) frequency offset and noise samples, respectively. To compute the coarse frequency estimate, samples of 16 symbols apart (e.g. 30 and 32, 31 and 33 in FIG. 4) are first differentially multiplied according to the equation 2

$${r}_{n} {r}_{n - 16}^{*} = {ⅇ}^{j2 π f ( 16 )} {\sum }_{k1}^{} {\sum }_{k2}^{} {h}_{k1} {h}_{k2} {a}_{n - k1} {a}_{n - k2} + noise terms \qquad ( 2 )$$

These terms are then averaged over several samples of length Lm and the angle of the averaged sum is then computed to yield an estimated phase shift due to frequency offset. For ease of hardware implementation, the number of samples used for averaging is preferably at power of 2 so that division operation is simply reduced to hardware register shifting. The estimate phase shift is then scaled to obtain

$$\hat{f} = \frac{arg \{ E ( {r}_{n} {r}_{n - 16}^{*} ) \}}{2 π ( 16 )} \qquad ( 3 )$$

Mathematically equation 3, can be shown to obtain an unbiased estimate of the frequency offset provided the sequence used is statistically uncorrelated (which is fulfilled by PN or CAZAC sequence).

Regarding statistical independence or an uncorrelated sequence, it should be noted that each differentially multiplied sample rₙr_{n-L}* has both statistically dependent and independent product terms. The process of averaging is to remove the statistically independent product terms while retaining only terms with identical symbols arising from successive sequence.

The term “statistically independent” is used interchangeably here with the term “uncorrelated”, although in the field of statistics, they are technically slightly different.

Note that more samples can be used for averaging to yield a more accurate estimate if the sequence is of longer periodicity. Alternatively, more sequences may also be used for averaging.

It should be noted that the operation of the frequency estimator may continue as long as the samples contain the periodic preamble. Before the start of the actual data transmission, a control signal to the estimator must be asserted to freeze the computation. Moreover, this results in power saving as it allows clock gating to be used. The assertion of the control signal to halt computation is readily performed by a frame synchronization unit, aided by a timing recovery unit such as timing correlator (as mentioned earlier) which detects the end of the preamble. Such units are well known in the art.

Failure to stop the computation after the beginning of data transmission will render the estimate unreliable. The operation of the frequency estimator will resume at the start of every new packet transmission.

FIG. 7 compares the estimation accuracy of the proposed frequency estimator, with other known Maximum Likelihood frequency estimation techniques such as one by Marco Luise et al in “Carrier Frequency recovery in All-Digital Modems for Burst Mode Transmission, IEEE Trans on Communications vol 43, Feb 1995” and Fitz in “Decision Directed Burst Mode Carrier Synchronization Techniques, IEEE Trans on Communications vol 40 Oct 1992” are used for performance comparison. The simulation is performed with the following settings.

1. Exponential power delayed Rayleigh fading channel, as adopted in the IEEE 802.11 criteria, of a 50 ns rms delay spread.

2. Oversampling ratio of 2 samples per symbol.

3 Variance of estimators are estimated over 1000 packets.

4 A fixed normalized frequency offset of 0.03 is assumed.

5. Other frequency estimators are all data-aided.

6. Preamble using 2 CAZAC sequences, of QPSK modulation

The simulation result shown in FIG. 7 illustrates the effectiveness of the proposed estimator over these prior art estimators. Note that a further advantage of the embodiment is that it does not require any prior timing information. It should also be noted that the estimator works for both frequency selective and non-selective channels.

In another embodiment of the invention as illustrated in FIG. 5, the estimated frequency error 47 computed by the frequency estimator 48 is used to initialize a carrier-tracking loop 50. A carrier-tracking loop is typically used in communication receivers to remove and track any small residual frequency and phase offset that may exist in the received signal 40 due to frequency mismatches of transmitting and receiving Local Oscillators (external to the carrier tracking loop 50). A phase error voltage 49 corresponding to any frequency or phase offset in signal 42 is detected and generated by the phase detector 43. The phase detector is such that it is designed to be insensitive to phase offset contributed by the data modulation. Known to those skilled in the art, there are many established methods for performing phase detection. The phase error 49 is passed through a loop filter 44, designed with a low-pass frequency characteristic, to smooth the noisy error signal. In a preferred arrangement, the loop filter 44 is implemented digitally for greater stability. The smoothed error signal is fed to the NCO 45 to reproduce a reference carrier signal 46 to correct for any frequency and phase mismatches of incoming signal 40.

In a conventional carrier-tracking loop (FIG. 5), the reference carrier signal 46 at the output of the NCO 45 is normally tuned to the expected frequency of the incoming signal 40. In most cases, the frequency of the NCO 45 never agrees with the frequency of incoming signal 40. It is also well known that the conventional carrier-tracking loop normally takes a certain amount of time to bring the frequency and phase of 46 close to agreement with the incoming signal 40. This amount of time, known as acquisition period, depends on the design parameters of the loop filter 44 and also on the signal to noise ratio of the incoming signal 40.

In the embodiment, the frequency estimate 47 computed by the frequency estimator 48 is used to initialise the NCO 45 to speed up carrier acquisition. As discussed before, an NCO typically comprises a phase register follows by an accumulator and a Look-Up-Table. The frequency estimate 47 is latched into the phase register of the NCO 45 to bring the frequency of the reference signal 46 closer to the frequency of the incoming signal 40. As a result, the acquisition period is shortened and the signal 42 reaches a steady state in which phase and frequency offset is near zero. The frequency and phase corrected signal 42 is then sent to either an equaliser or demodulation unit for final demodulation.

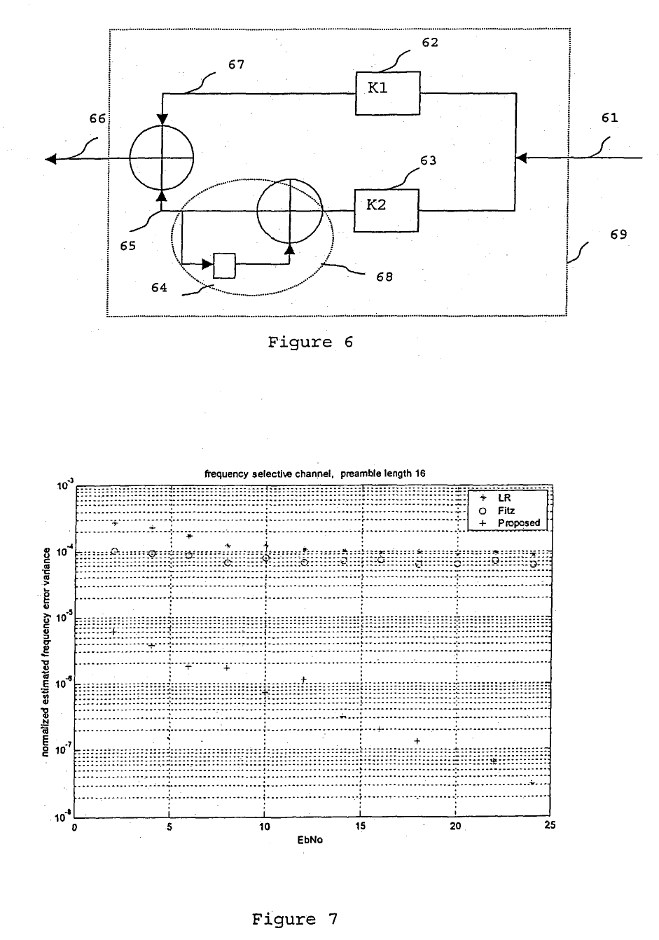

In an alternative arrangement, the frequency estimate computed by the frequency estimator 48 is used to directly initialize the Loop filter 44 to speed up carrier acquisition. Referring to FIG. 6, a modified loop filter 69 of the carrier-tracking loop 50 is implemented digitally. The output of the loop filter 66 is a linear combination of 67, the phase error multiplied by a gain factor K1, 62 and 65, an integral of the phase error weighted by another gain factor. K2 63. The frequency estimate may be latched directly into the integral register 64. Therefore one can see that during steady state where the phase error 61 is zero, a value at the output of the accumulator 68 is held constant at the output 66 for the NCO to tuned signal 46 (FIG. 5) closer to the incoming frequency.

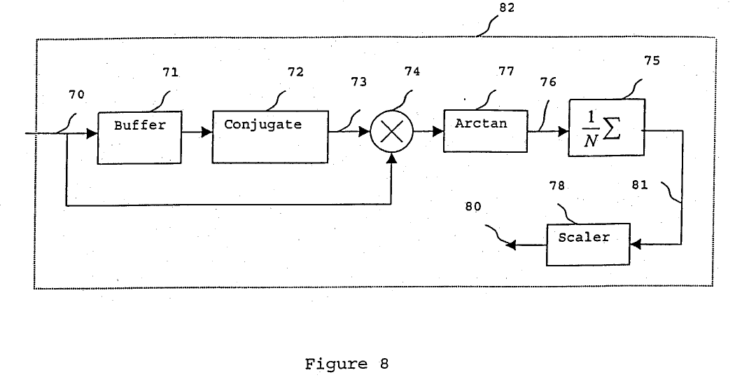

In the embodiment of FIG. 8 a slight variation in implementation of a frequency estimator 82 is shown. The “inverse tangent and averager are swapped in position. Line 70 represents a signal that has been sampled by an Analog to Digital Converter with an oversampling ratio m (e.g. 2 or 4 samples/symbol). The sign al is assumed to be downconverted from a RF/IF frequency to its complex baseband equivalent by a quadrature mixer (not shown). Although the final center frequency is lowered, the original frequency offset is still present. Depending on the length L of the each sequence in the preamble, a memory buffer 71 of depth Lm samples is used to store and delay the incoming samples. Complex conjugate 72 operation is then performed on the delayed samples. The delayed complex conjugate signal 73 is then multiplied with the received signal 70 by a complex multiplier 74. Unit 77, implementing an “inverse tangent” function, operates on the output samples of the complex multiplier 74 to produced an estimated rotated phase angle 76 corresponding to the frequency offset. The estimated angles 76 are then averaged over several samples by an averager 75 to reduce the noise variance for improved performance. The output of the averager 81 is then sent to the scaler 78 for removing frequency bias and the estimated frequency offset is finally processed as 80.

When compared to the embodiment of FIG. 2, this variant suffers from slight degradation in estimation performance but is nonetheless a superior estimator in the presence of a frequency selective channel. The choice between the two implementations depends on the preference of the designer and on the required performance.

Apart from the swapping of the “inverse tangent” 77 and averager 78, the remaining operation and usage of this frequency estimator 82 is almost identical to the first embodiment.

The proposed frequency estimators can be applied to any burst packet transmission system that uses periodic sequences during the preamble. One application is in the implementation of a receiver conforming to the IEEE Wireless Personal Area Network (WPAN) 802.15.3 specification. In that draft specification (ver 8), a CAZAC sequence of 16 symbols each are repeated over 10 times and constitute part of the preamble.

Another potential application is in high data rate Bluetooth Release 2.0 that is widely expected to support single carrier 2/4/8PSK modulation.

The described embodiments is also very advantageous in Time Division Multiple access (TDMA) or Time Division Duplex (TDD) communications system that operates on burst nature where fast carrier acquisition is mandatory for proper operation.

The various features of the embodiments are freely combinable with each other. Alterations and modifications as would be obvious to those skilled in the art are intended to be incorporated within the scope hereof.

1. An estimator for determining an estimate of frequency offset associated with a received burst signal having a repeated training sequence; the estimator comprising:
means for differentially multiplying a sample of a first said sequence with a corresponding sample of a second said sequence;
means for determining a phase rotation angle dependent on said difference and which angle is indicative of said estimate.

2. An estimator according to claim 1 wherein the samples of each said training sequence are statistically independent, and wherein the estimator further comprises means for averaging said differences for a number of samples of said first and second sequences.

3. An estimator according to claim 2 wherein said sequences are Pseudo Random or Constant Amplitude Zero Auto-Correlation sequences.

4. An estimator according to claim 1 wherein said phase angle determining means comprises an arc tangent function applied to said difference.

5. A frequency corrector comprising an estimator as claimed in claim 1 and a frequency shifter which shifts the phase of said received signal by said phase rotation angle.

6. A corrector according to claim 5 wherein the phase shifter comprises an NCO having an input coupled to said phase rotation output and which generates a correction frequency dependent on said output and which is mixed with said received signal.

7. A method of estimating a frequency offset associated with a received signal having a repeated training sequence, the method comprising:
differentially multiplying a sample of a first said sequence with a corresponding sample of a second said sequence;
determining a phase rotation angle dependent on said difference and which angle is indicative of said estimate.

8. A method according to claim 7 wherein the samples of each said training sequence are statistically independent, and wherein the method further comprises averaging said differences for a number of samples of said first and second sequences.

9. A method according to claim 8 wherein said sequences are Pseudo Random or Constant Amplitude Zero Auto-Correlation sequences.

10. A method according to claim 7 wherein said phase angle determining comprises applying an arc tangent function to said difference.

11. A method of correcting the frequency offset of a received signal, the method comprising a method according to claim 7 and shifting the phase of said received signal by said phase rotation angle.

12. A method according to claim 11 further comprising generating a correction frequency dependent on said phase rotation angle output and mixing this with said received signal.
